(19) United States
(12) Patent Application Publication
(10) Pub. No.: US 2022/0274462 A1
(43) Pub. Date: Sep. 1, 2022

(54) Unique Automobile HVAC System Design and Components

(71) Applicant: Stephen G. Ehrman, Indianapolis, IN (US)

(72) Inventor: Stephen G. Ehrman, Indianapolis, IN (US)

(21) Appl. No.: 17/187,856

(22) Filed: Feb. 28, 2021

(51) Int. Cl. B60H 1/24; B60H 3/00

(52) U.S. Cl. CPC B60H 1/247; B60H 3/0078

(57) ABSTRACT

The invention is applicable to the technical field of Air-Conditioning systems for automobiles and all vehicles. Current heating, ventilating and air conditioning systems in automobiles attempt to blow air directedly at occupants and do not circulate and return air effectively before recirculating within the cabin. Further, existing systems create undesirable air stratification and redistribute air borane contaminants causing occupant fatigue and discomfort. This invention solves all these issues by using a new air diffuser design, strategic airflow patterns, and a ducted return air system. This invention provides a thermal envelope of comfort and allows airflow rates that capture more contaminants. The system additionally allows control of cabin pressurization so hot or cold outside air does not leak into the cabin unnecessarily. Additionally, the invention provides for devices to be incorporated that remove, reduce or eliminate the spread of virus and bacteria.

### CROSS-REFERENCE TO RELATED APPLICATIONS

US Provisional application Number: None

### STATEMENT REGARDING FEDERALLY SPONSORED RESEARCH OR DEVELOPMENT

Reference: None

### REFERENCE TO SEQUENCE LISTING, A TABLE, MICROFICHE OR A COMPUTER PROGRAM LISTING COMPACT DISK APPENDIX

Reference: None

### BACKGROUND OF INVENTION

### Field of the Invention

The present invention is within the technical field of heating, ventilating and air conditioning systems (HVAC). More particularly, the present invention is within the automobile and mobile vehicle HVAC systems.

### Description of the Related Art

The basic design and components of HVAC (Heating Ventilating and Air Conditioning) systems for vehicles has not greatly changed since first introduced as a factory option 80 years ago.

In the current conventional system, conditioned air is directed into the cabin and generally directed to occupants thru diffusers that blow cold or hot air in randomly directed user adjusted paths. Return air from the cabin is not controlled thru ducting, rather it has a tendency to cross paths with the supply air before returned to the main fan. While returning in this fashion, the stale air will cause dust and contaminates to be circulated and spread thru the cabin. Attempts to upgrade existing systems have incorporated zone controls thru complicated electronic settings, which are confusing to the occupants. Further, the diffuser air vents are numerous, include many manual directional and flow controls that are typically underutilized, and the design of such are more aesthetic than functional.

Thus, current vehicular HVAC systems cause occupants to be uncomfortable, are distracting to drivers when they adjust settings, cause the cabin to exhibit uncomfortable air flows, spread dirt, dust, contaminates and virus, and do not incorporate new space control strategies such as space pressurization control. Therefore, as vehicles' interiors have rapidly developed in recent years, and cabins updated with many new features demanding a more logical physical layout, a new and redesigned HVAC system for vehicles is needed.

### SUMMARY OF INVENTION

### Brief Summary of the Invention

It is an object of the present invention to provide an efficient and effective HVAC mobile cabin design using new and unobvious components able to facilitate a comfortable, clean and stable temperature environment in a vehicle cabin. More particularly, this invention improves automobile air treatment systems, airflow patterns in the cabin, filtration and comfort using new and novel components and purposely designed air flow patterns. More importantly, with this invention's novel return air system, the spread of virus and bacteria between occupants is reduced by eliminating the contaminants from being haphazardly spread to the occupants and surfaces.

### BRIEF DESCRIPTION OF THE DRAWINGS

FIG. 1 is an interior side view of a vehicle showing a main component of the present invention.

FIG. 2 is a top view perspective of a vehicle using the present invention.

FIG. 3 is a side view of a roof component of a vehicle using the present invention.

FIG. 4 is a top and side view of the main supply air component of the present invention.

FIG. 5 is a side view of a secondary supply air component of the present invention.

FIG. 6 is a diagrammatic representation of the present invention.

FIG. 7 is an alternative side view of the main diffuser components within a vehicle further including airflow paths of the present invention.

### DETAILED DESCRIPTION OF THE INVENTION

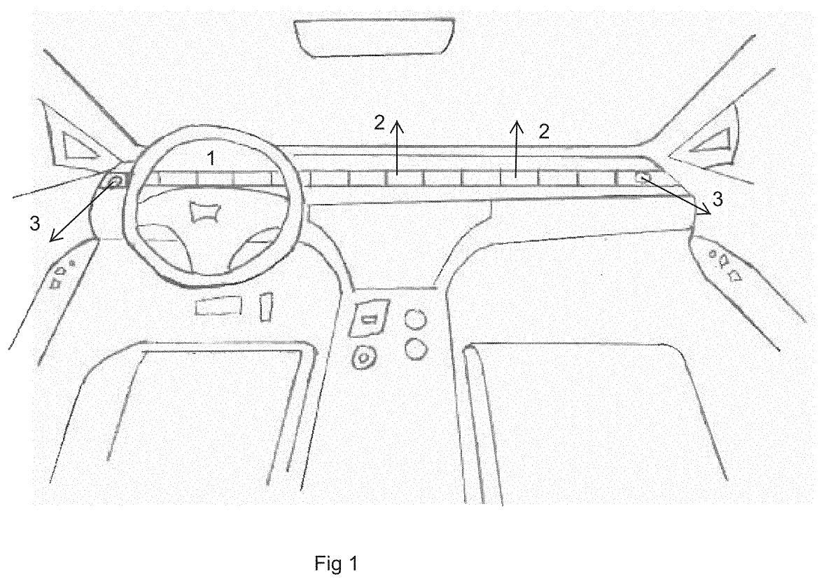

Referring now to the invention in more detail, FIG. 1 shows the present invention, including preferred embodiments. Located in a vehicle front dashboard assembly is a component of the present invention 1, called the ‘diffuser assembly’. The vent has louvered openings to discharge air 2 into the automobile cabin at a low velocity. Additionally, on each side is shown front cabin diffuser higher velocity directional diffusers 3.

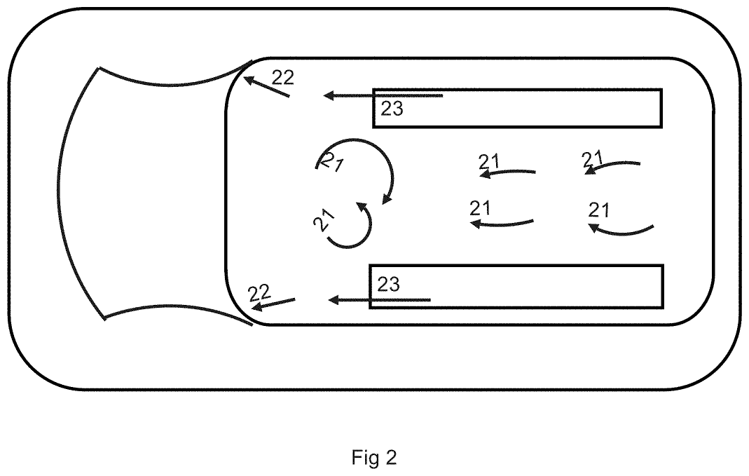

FIG. 2 shows a top-down view of a vehicle containing the present invention. The desired airflow patterns are depicted showing the cabin air pulled up towards the ceiling return system traveling into a perforated headliner 21 allowing the air to be pulled into the return duct system 22 to be returned into the main fan of the HVAC system. Additionally, elongated return opening grills having larger openings than ceiling liner perforations may also serve as openings in the headliner 23 allowing air to enter the ceiling cavity.

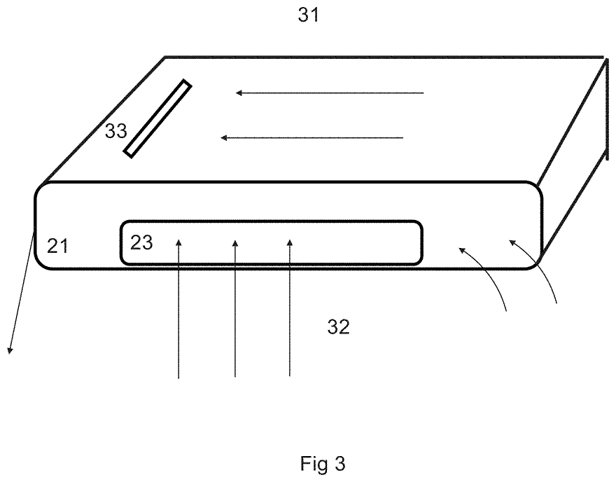

FIG. 3 shows an isolated side view of area between the roof outside of a vehicle 31 and the ceiling or headliner inside the mobile vehicle cabin 32. Such area between 31 and 32 may commonly be defined or referred to as the ceiling cavity. The cabin air is pulled toward the ceiling return thru a perforated headliner 21 and additionally, or instead of, air opening grills 23. The encapsulated area below the outside top 31 and inside 32 ceiling cavity, may also be made to accept or contain such air cleaning devises as a ultra-violet lights, rolling replaceable filtration media, an ionization, or scenting system, or the like depicted as an element of the system 33.

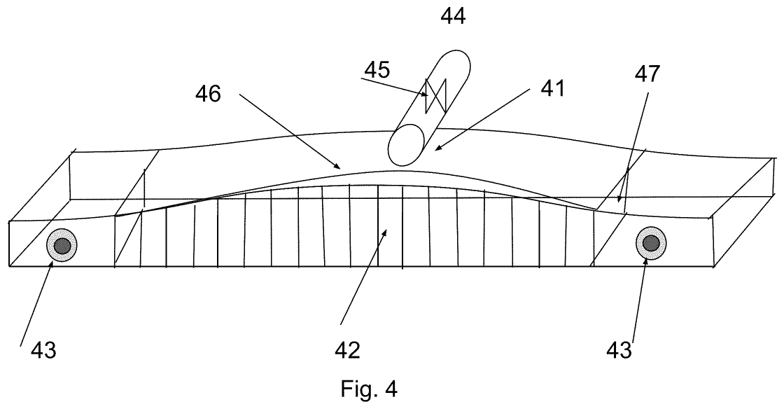

FIG. 4 shows the horizontal vent assembly constructed to be an air-tight pressurized plenum 41. The main vents 42 are louvered openings along the length of the assembly. Also incorporated are high velocity direction diffuser 43 placed at strategic locations. The air inlet connection is shown 44 which may be of various size and shape. Within the inlet or at the inlet opening, a fan 45, may be provided to help boost the airflow to the assembly. A typical baffle distribution divider is shown 46. A separating chamber 47 is shown for converting velocity pressure to static pressure for the high velocity diffuser.

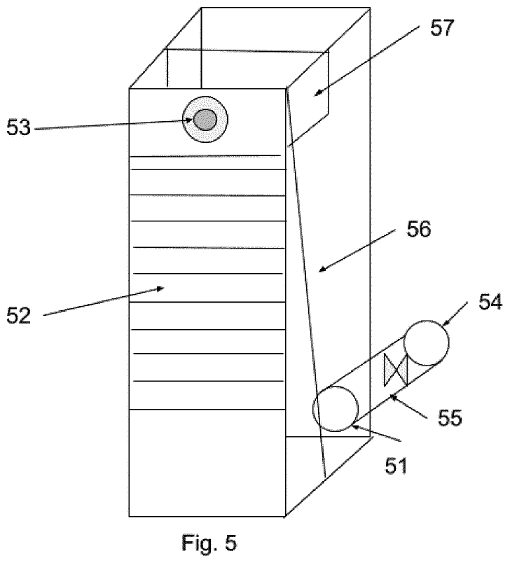

FIG. 5 shows the vertical vent assembly constructed to be an air=tight pressurized plenum 51. The main vents 52 are louvered openings along the face of the assembly. Also incorporated are high velocity directional diffusers 53. The air inlet connection is shown 54 which may be of various size and shape. Within the inlet connection a fan 55 may be provided in order to help boost the airflow to the assembly. A perforated air diffuser plate is within the assembly 56 dispersing and directing the pressure of the air thru the high and low velocity diffusers. A separating chamber 57 for converting velocity pressure to static pressure for the high velocity diffuser.

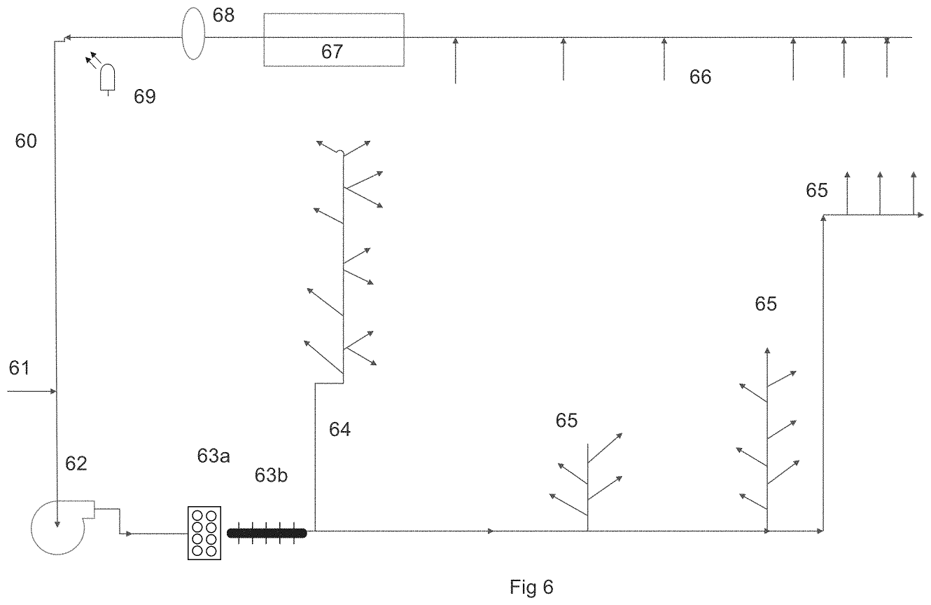

FIG. 6 depicts the air flow diagrammatically showing major components and resulting air flow patterns. Air returning from the cabin 60 may mix with outside air 61 and is introduced into the main system fan 62. The air receives the benefit of cooling 63a or heating 63b process and is distributed to the front diffuser assembly 64 and other cabin diffusers 65. The air is drawn into the ceiling 66 perforations and other openings, then may pass thru a high efficiency filter 67 and other air treatment devices 68 such as bipolar ionization and UV lighting 69. This air then returns 60 to complete the cycle again.

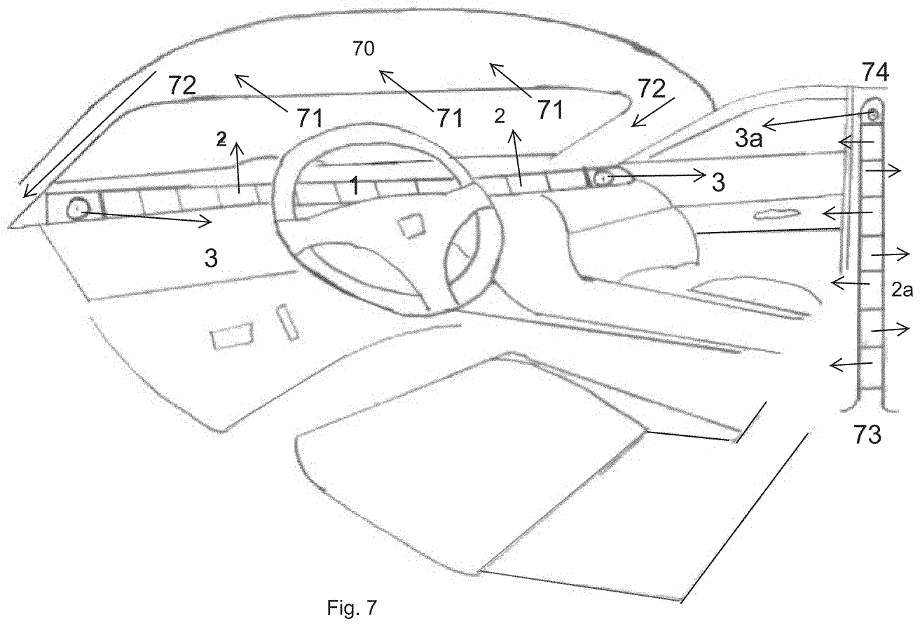

FIG. 7 shows the present invention from a side front view where the return airflow is further detailed and shown entering ceiling cavity 70 on its way back to the main HVAC fan. The present invention assembly 1 discharges low velocity air 2 and higher velocity air 3 within the cabin. The air is drawn into the ceiling openings 71 and progresses back into the automobile HVAC system thru duct paths 72. A secondary similar diffuser assembly is shown 73, mounted vertically along a vehicle's roof vertical support post 74 which is usually present between a front and rear door. This system contains the same type discharge low velocity openings 2a and higher velocity directional diffuser 3a.

The advantages of the present invention include, without limitation, greater comfort for occupants, healthier cabin air, more cognitive awareness for the driver and passengers, streamlined front ventilation component design allowing valuable dash space freed up for ever increasing driver interface screens, and easier access of the HVAC components for maintenance. This invention solves the problem of uneven air delivery caused by the current used series of separate vents haphazardly designed to be manually synced and directed by occupants. This invention also provides for compete and even air return, cleansing, treatment and filtration of the returned cabin air before being recirculated.

In a broad embodiment, the present invention provides new components and design of cabin HVAC systems providing airflow so that the envelope of the vehicle and the occupants receive fully treated HVAC air with a system that is easy to use.

While the foregoing written description of the invention enables one of ordinary skill to make and use the invention in the best mode, those of ordinary skill in the art will also appreciate existence of variations, combinations and equivalents of the broad embodiment, method and examples also presented in the additional embodiments presented below. The invention should therefore not be limited by the above or below embodiments, designs, methods and examples, but should instead be interpreted to include and contemplate all the common variations that specific vehicles may require as modifications and additions.

In the preferred embodiment of the present invention, air that has been filtered, heated or cooled or both is delivered into the cabin thru low velocity diffusers designed to strategically treat the interior envelope of the vehicle, to be aesthetically pleasing, quiet and effective at isolating the outdoor environment from effecting the interior cabin of the vehicle. The air is drawn into the ceiling thru perforation or ceiling vent openings, providing apparatuses to clean the air, which is to be returned to be heated or cooled, then circulated through the main system again. The total amount of air circulated per minute (CFM) may be made to be higher than a current traditional system since it is more evenly distributed in the cabin thereby allowing greater occupant comfort, providing better isolation of the exterior temperature extremes, and provide better return of contaminants to be filtered and removed from the cabin.

In other embodiments of the present invention, the return air system is designed to direct, collect, clean, treat and then return the air to be recycled again.

Additionally, booster fans may be provided at the inlet of the new invention's diffuser assembly to pressurize and control each diffuser assemble. A baffle diffuser plate may be provided to help distribute the air evenly across the main low velocity ventilation diffusers while providing pressurized air to the occupant directional high pressure diffuser.

In an additional embodiment of the invention, air is collected at the ceiling and may pass thru a perforated ceiling headliner that is statically charged and cleanable and may also or otherwise pass thru larger ventilation collection openings. The return air is then further cleaned with standard filtration components and then returned.

The present invention contemplates and provides the basis for the unobvious application and design of devices for regulation of outside air amounts to flush out cabin when clean air is available, and automatically regulate to reduce outside air when stopped in traffic or around other odorous and harmful environments, while maintaining pressurization in the cabin for further comfort and contaminate control. Additionally, it is a simple addition to use energy recovery media between incoming outside air and stale cabin exhaust air so that the HVAC system is not strained or needing excessive oversizing in order to handle a larger quantities of outside air which may now be introduced to provide the aforementioned benefits using the present invention.

I claim:

1. An air-conditioning system for automobiles and mobile vehicles comprising unique supply air and return air components.

2. The system as in claim 1 said unique supply components comprising an assembly of a plurality of low velocity diffuser openings and high velocity directional diffusers.

3. The system as in claim 1 with said return air components incorporated into the vehicle roof cavity and headliner to pull the air up from the cabin and return it to the main system.

4. An assembly of low velocity diffusers and high velocity directional diffusers having additional items such as inline air fan booster and internal diffuser plate assembly.

5. A return air system for mobile vehicles using a cleanable headliner comprising perforated openings and plenum cavity.

6. The return air system in claim 5 with said cleanable liner being a statically charged filtration composition.

7. The air system as in claim 5 with plenum cavity able to contain air cleaning components such as air filters, ultra violet lights, bi-polar ionization treatments and the like.
